(19) United States
(12) Patent Application Publication
(10) Pub. No.: US 2004/0140890 A1
(43) Pub. Date: Jul. 22, 2004

(54) Device for interrogating the locked condition of a vehicle safety belt buckle

(76) Inventors: Robert Hartmann, Reutlingen (DE); Martin Zapf, Ottmannsreuth (DE)

Correspondence Address: HUNTON & WILLIAMS LLP, 1601 BRYAN STREET, ENERGY PLAZA - 30TH FLOOR, DALLAS, TX, 75201, US

(21) Appl. No.: 10/722,931

(22) Filed: Nov. 25, 2003

(30) Foreign Application Priority Data
Nov. 27, 2002 (DE) 102 55 324.6-22

(51) Int. Cl. B60Q 1/00

(52) U.S. Cl. 340/457.1; 340/505; 340/686.1

(57) ABSTRACT

In one configuration, a device has been provided for recognizing the locked condition of a seat belt buckle. In this configuration, the device include a sensor that directly interrogates the condition of the seat belt buckle by a change in inductance. In another configuration, a device has been provide that recognizes a condition of a safety belt buckle. In this configuration, the device includes a sensor that directly interrogates the condition of the seat belt buckle by a change in inductance.

### TECHNICAL FIELD OF THE INVENTION

This invention relates in general to safety belt buckles and more specifically to a device for interrogating the locked condition of a safety belt buckle for vehicles.

### BACKGROUND OF THE INVENTION

Two principles are known in the state of the art for recognizing the locked condition of safety belt buckles. On the one hand electromagnetic switching contacts are used, which in their construction represent a mechanical belt buckle switch. In this, the locked condition is measured by means of an integrated micro-switch, a push button switch or a button. Such devices are known, for instance, from the German Patent Application DE 100 58 978 A1. On the other hand, in recent times Hall sensors with moving magnets are mainly used. Such devices are known for example from European Patent EP 0 842 832 B1, the European Patent Application P 0 861 763 A2, the PCT application WO 99/55561 and the German Patent Application DE 100 58 978 A1. In these, the locked condition is either directly or indirectly interrogated via the ejector. Because of the combination of magnets and moving provisions for the magnets, for example a compression spring, the construction is multi-part.

Fundamental problems occur in the above approaches. The traditional systems are sensitive to interfering external magnetic fields because of the operating principle. For example, if an electrical device is close to the belt buckle, it cannot be obviated that a interfering magnetic field overlays or diverts the magnetic field of the Hall sensor in such a manner that the Hall sensor no longer correctly recognizes the condition.

In addition, indirect interrogation systems do not permit unambiguous interrogation of the condition of the locking component as they are used indirectly. If the activating component of the sensor fails to operate for any reason, for example wear, fatigue or dirt, the sensor cannot recognize the true condition. If, for example, the activation of the ejector for the moveable magnet is interrupted, the Hall sensor recognizes a permanently open seat belt buckle. If the compression spring become fatigued, the moveable magnet is moved from its position when the buckle is unfastened and the Hall sensor recognizes a permanently locked seat belt buckle. In the same way the operating principle does not provide a clear and precise switching point.

Furthermore, systems are known from the state of the art which have a sensor which registers the change in the direction of a magnetic field as a change in the electrical resistance of the sensor. The magnetic sensor uses an anisotropic magnetic effect and an auxiliary magnet. Such sensors are, for example, known from the European Patent Application EP 1 125 802 A2. These systems require the presence of a bias/auxiliary magnet.

However, magnets are subject to numerous of processes, for example such as ageing whereby the strength of the magnet declines. To ensure a recognition being reliable to a certain extent even in the presence of interfering magnetic fields, the contribution of a magnetic shield plate is suggested.

In addition, the anisotropic effect is rather small, in the region of a few percent (˜≦5%), and dependent on environmental parameters, for example temperature, thereby placing further demands on the evaluation circuit.

The results of faulty recognition of the locked condition could, for example, include the failure of an airbag to be released in the case of an accident.

### SUMMARY OF THE INVENTION

From the foregoing it may be appreciated that a need has arisen for an interrogation system for recognizing the condition of the locking component of a seat belt buckle.

According to one aspect of the invention, a device has been provided for recognizing the locked condition of a seat belt buckle. The device in this aspect includes a sensor that directly interrogates the condition of the seat belt buckle by a change in inductance.

According to another aspect of the invention, a seat belt buckle has been provided. The seat belt buckle includes a seat belt buckle carrier, a seat belt buckle tongue, an ejector, a locking component, and a device for recognizing the locked condition of a seat belt buckle. The device in this aspect includes a sensor that directly interrogates the condition of the seat belt buckle by a change in inductance.

According to another aspect of the invention, a device has been provided for recognizing a condition of a safety belt buckle. The device in this aspect includes a sensor that directly interrogates a locked condition by a change in a coupling factor.

According to another aspect of the invention, a seat belt buckle has been provided. The seat belt buckle includes a seat belt buckle carrier, a seat belt buckle tongue, an ejector, a locking component, and a device a device for recognizing the locked condition of a seat belt buckle. The device in this aspect includes a sensor that directly interrogates a locked condition by a change in a coupling factor.

The present invention provides a profusion of technical advantages that includes an interrogation system for recognizing the condition of the locking component of a seat belt buckle which is insensitive to strong external magnetic fields.

Another technical advantage of the present invention includes an interrogation system for recognizing the condition of the locking component of a seat belt buckle which interrogates the locking component directly.

Another technical advantage of the present invention includes an interrogation system for recognizing the condition of the locking component of a seat belt buckle which which can be integrated into a seat belt buckle.

Other technical advantages are readily apparent to one skilled in the art from the following figures, description, and claims.

### BRIEF DESCRIPTION OF THE DRAWINGS

For a more complete understanding of the present invention and the advantages thereof, reference is now made to the following brief description, taken in connection with the accompanying drawings and detailed description, wherein like reference numerals represent like parts, in which:

FIG. 1 is a state of the art locked safety belt buckle;

FIG. 2 is a state of the art unlocked safety belt buckle;

FIG. 3 is an embodiment of a locked safety belt buckle according to an aspect of the invention whereby

FIG. 3a is a side view,

FIG. 3b is a plan view with the section B-B marked and

FIG. 3c is a side view along the section B-B;

FIG. 4 is an embodiment of an unlocked safety belt buckle according to an aspect of the invention whereby

FIG. 4a is a side view,

FIG. 4b is a plan view with the section A-A marked, and

FIG. 4c is a side view along the section A-A;

FIG. 5 is a sensor circuit using the oscillation principle; and

FIG. 6 is an embodiment of a sensor circuit.

### DETAILED DESCRIPTION OF THE INVENTION

It should be understood at the outset that although an exemplary implementation of the present invention is illustrated below, the present invention may be implemented using any number of techniques, whether currently known or in existence. The present invention should in no way be limited to the exemplary implementations, drawings, and techniques illustrated below, including the exemplary design and implementation illustrated and described herein.

According to one aspect of the invention, a change in inductance is achieved by the interaction of one of the materials identified below with a sensor, based on this interaction a statement regarding the status of the locking component can be made, as the change in inductance is directly interrogated by locking the seat belt buckle tongue in the seat belt buckle.

Diamagnetic, paramagnetic as well as ferromagnetic materials can in principle be used to change inductance. Different levels of effect and different effects are produced by the selection of the material. If a diamagnetic material is used, the inductance reduces. If a paramagnetic material is used, the inductance increases. If ferromagnetic materials are used, the inductance increases significantly.

Alternatively, the change of the magnetic coupling factor k of two coupled coils can be used in place of the change in inductance. The coupling factor k describes the relationship of the magnetic couplings between two electrical circuits 1 and 2. The following formula applies for the coupling factor between two electrical circuits with inductances L₁ und L₂ and the mutual inductance M₁₂:

$$k = \frac{{M}_{12}}{\sqrt{{L}_{1} {L}_{2}}}$$

In principle, diamagnetic, paramagnetic as well as ferromagnetic materials can be used to change the coupling factor k. Different levels of effect and different effects are produced by the selection of the material. If a diamagnetic material is selected, the coupling factor k reduces. If a paramagnetic material is used, the coupling factor k increases. If ferromagnetic materials are used, coupling factor k reduces significantly.

The effects described above are of a static nature and therefore enable the condition to be recognized precisely.

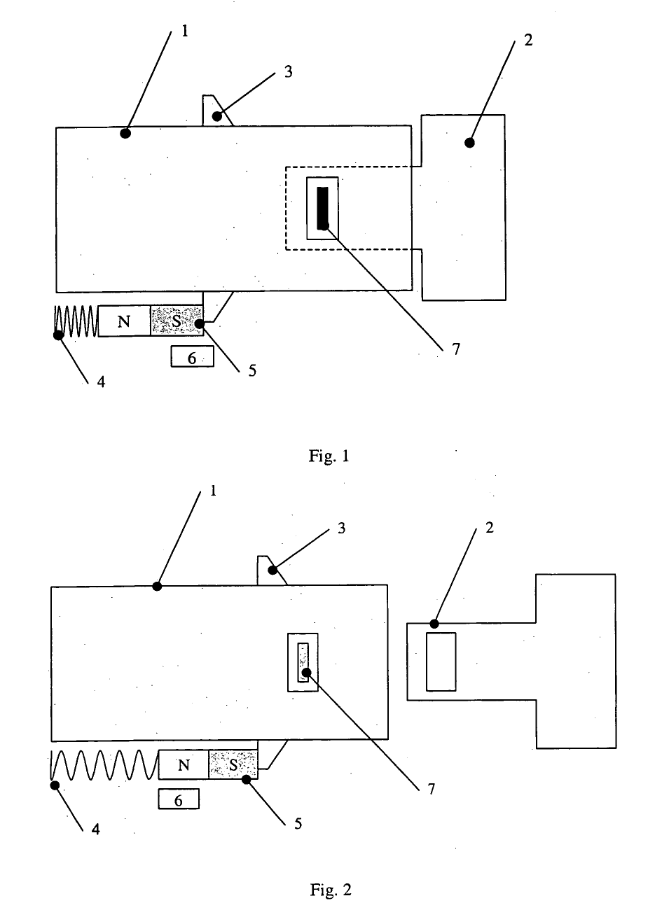

The operating principle of a state of the art safety belt buckle can be seen in FIGS. 1 and 2. The following initially describes the locked condition in FIG. 1.

The seat belt buckle consists of a seat belt buckle carrier (1) and a seat belt buckle tongue (2). The seat belt buckle carrier (1) comprises an integrated ejector (3) and a locking component (7). A moveable magnet (5) is provided in between the ejector (3) and a compression spring (4). The magnet (5) is arranged in such a way that its position relative to a suitably positioned Hall sensor (6) can be altered by the ejector (3) and the compression spring (4).

In order to lock the seat belt buckle, the seat belt buckle tongue (2) is introduced into the seat belt buckle carrier (1) in accordance with FIG. 1. This causes the position of the ejector (3) to change at the same time. The locking component (7) is locked. The ejector (3) in turn changes the position of the moveable magnet (5), which is now moved against the resistance of the compression spring (4). A suitably positioned Hall sensor (6) recognizes the position change of the moveable magnet (5) as a change in the field density and generates an electrical output signal, which indicates the locked condition.

If the locking component (7) is unlocked, the seat buckle tongue (2) can be withdrawn from the seat belt buckle carrier (1) as shown in FIG. 2. A compression spring—not shown in the Figures—changes the position of the ejector (3). Further on, the compressed compression spring (4) changes the position of the moveable magnet (5). A suitably positioned Hall sensor (6) recognizes the change in the density of the field and generates an electrical output signal, which indicates the unlocked condition.

This output signal can be further processed in a suitable control device.

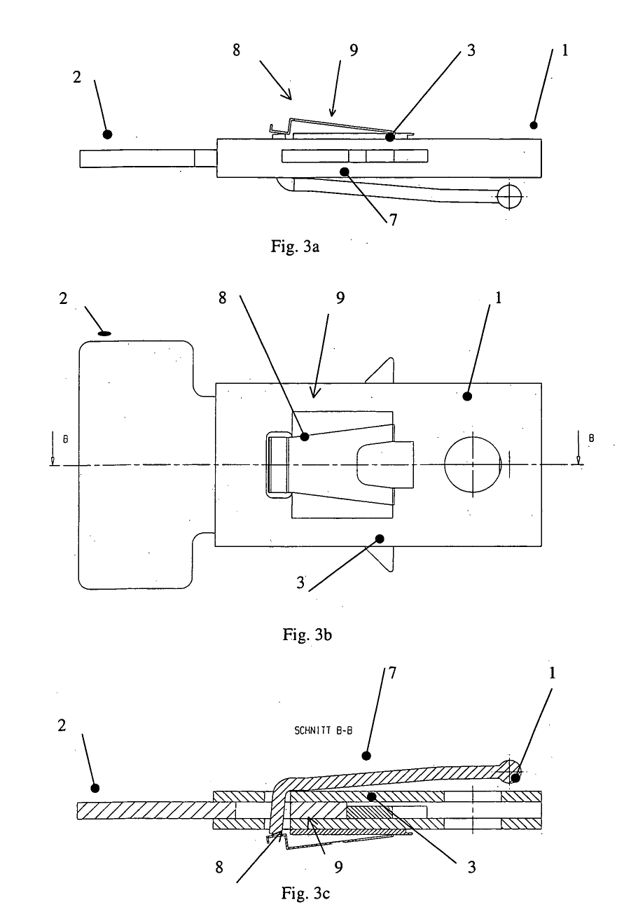

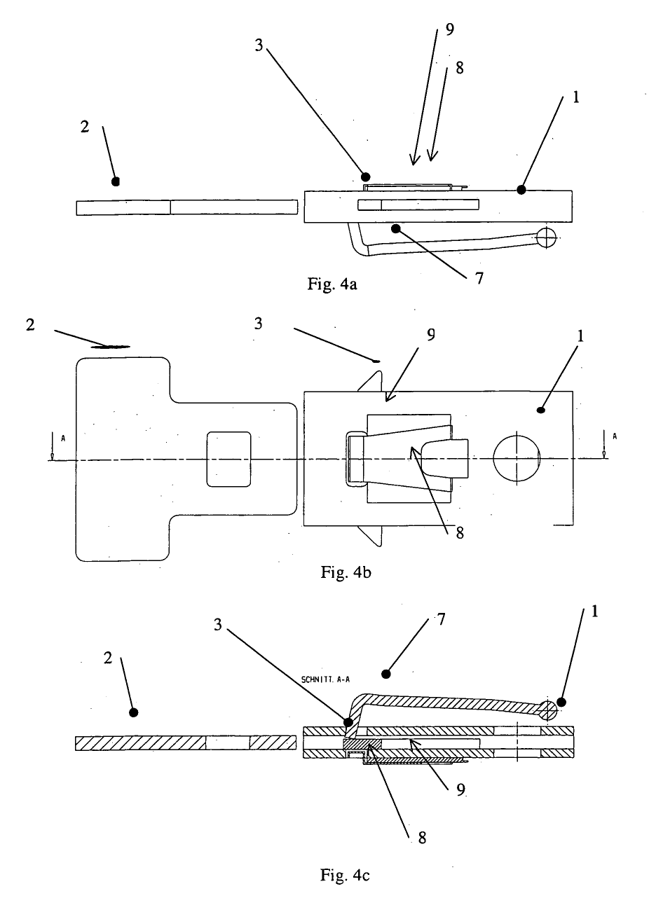

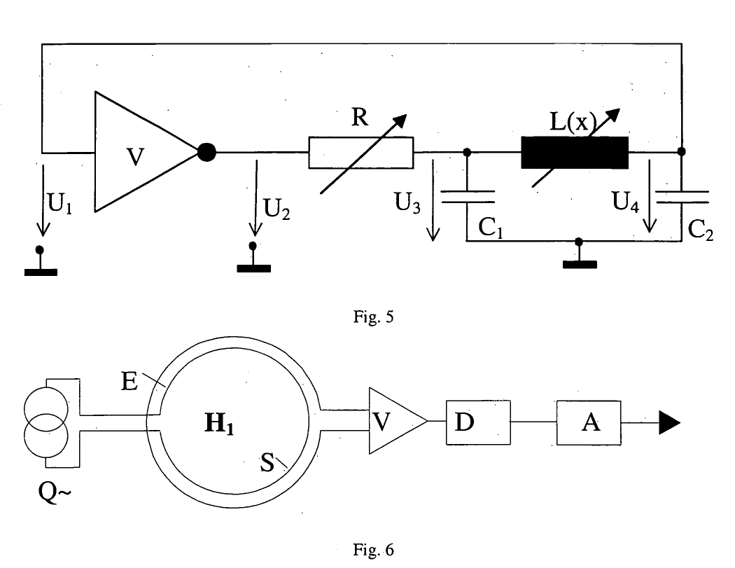

A device corresponding to an aspect of the invention for recognizing the condition of a seat belt buckle is described below in FIGS. 3a-3c and FIGS. 4a-4c. The present invention solves the problems mentioned above by the use of a sensor for the direct interrogation of the condition of a seat belt buckle. In particular, exact switching points can be realized and costs can be minimized with the device.

An embodiment according to an aspect of the invention consists of a seat belt buckle carrier (1) and a seat belt buckle tongue (2). The seat belt buckle carrier (1) comprises an integrated ejector (3), a locking component (7), a leaf spring (8) and a sensor (9). The sensor (9) is for example a printed circuit arranged in such a manner that the position of the seat belt buckle tongue (2) can be changed in relation to the sensor (9).

In addition, the locking component (7) or the leaf spring (8) or both can be made from a material, which changes the inductance or the coupling factor.

The device is described below using a change of inductance.

In order to lock the seat belt buckle, the seat belt buckle tongue (2) is introduced into the seat belt buckle carrier (1) of a seat belt buckle according to an embodiment of the an aspect of invention in accordance with FIGS. 3a-3c. The locking component (7) is locked and the leaf spring (8) is moved away from the sensor (9) as shown in FIG. 3c. This change in position of the leaf spring (8) is recognized by the sensor (9) and a suitable evaluation circuit generates an electrical output signal, which indicates the locked condition.

If the locking component (7) is unlocked, the seat buckle tongue (2) can be withdrawn from the seat belt buckle carrier (1) in accordance with FIGS. 4a-4c. The tensioned leaf spring (8) moves towards the sensor (9) as shown in FIG. 4c. This change in position of the leaf spring (8) is recognized by the sensor (9) and a suitable evaluation circuit generates an electrical output signal, which indicates the locking condition.

The electrical output signal can be further processed in a suitable control device.

A sensor layout in accordance with an aspect of the invention is explained below.

In a particularly preferred embodiment a planar inductive sensor L(x) is positioned on a circuit board as shown in FIG. (5). The inductance is applied as a multi-turn conductor loop in a planar manner on a printed circuit. Such sensors are, for example, described in the German Patent Application 102 423 85 by the applicant. In this, the inductance L changes depending on the distance x of a suitable activating component for the inductance L. In an aspect of present invention the leaf spring (8) is activated by the locking component (7). Depending on position x of the leaf spring (8) relative to the sensor (9), the inductance L of the sensor (9) varies.

In this, the sensor (9) is positioned between the seat belt buckle carrier (1) and the leaf spring (8) and joined with the carrier. The seat belt buckle carrier (1) itself comprises a groove at the position of the sensor as well as a recess at a small distance, for example 2 mm, relative to the face of the sensor (9) whereby inductive circular currents can be rejected.

The signal from the sensor (9) can now be processed in an evaluation circuit described below.

The change in the inductance L(x) can, for example, be evaluated by a simple LC oscillator circuit. Such a circuit is presented schematically in FIG. 5 (c) and comprises an inverted amplifier V, a resistance R, two ceramic capacitors C₁ and C₂ and the inductance L(x). The inductance is, for example, achieved by a printed circuit with an unattenuated inductance of 1 μH whereby the capacitors C₁ and C₂ and the inductance L(x) form a π-network, and the output of the π-network is fed back to an inverted amplifier.

Such LC oscillator circuits must meet an amplitude- and a phase-condition (cf. Tietze/Schenk: Halbleiter-Schaltungstechnik; Springer Verlag, Berlin, 10^{th} edition, Chapter 15.1 ff) so that on the one hand oscillation starts and on the other hand oscillation continues in a stable manner.

1. The loop gain of the overall circuit must be greater than one.

2. The voltage U₄ must be in phase with the voltage U₁ even in the case of an interrupted feedback arm.

The first condition referred to as the amplitude-condition and the second condition as the phase condition of the oscillator circuit.

If the π-network is resonant, the voltages U₃ and U₄ are in opposite phase. The inverting amplifier V shifts the voltage again by 180°, and so in the case of low resistance R the voltages U₂ and U₃ are in phase. Thus the phase condition is met.

The amplitude condition is met with low resistance R, an amplification V, which is greater than 2 and with a sufficiently large input resistance of the inverting amplifier.

The amplitude of voltage U₂ is increased by the factor “−V” in comparison with the amplitudes of voltage Ulby the inverting amplifier V. If the Q value of the π-network is high, the amplitudes of the voltages U₃ and U₄ are approximately equal. If the resistance R is small, the voltage drop over the resistance R is small and so the amplitude of voltage U₂ is greater than the amplitude of voltage U₃.

The oscillation conditions of the oscillator circuit may be violated if the resistance R is increased.

The resistance R and the capacitor C₁ form an RC-network. An additional phase shift therefore occurs between the voltages U₁ and U₃ when the resistance R is increased. If the phase shift reaches a certain value, the phase condition is violated and the oscillation ceases. This state is reached at the latest when the voltages U₁ and U₄ run into negative feed-back when the feed-back is interrupted.

In a similar manner, an increase in the resistance R produces an increased voltage drop in the resistance R. The amplitude of the voltage U₃ reduces. If the relationship of the voltage amplitudes U₂ to U₃ decreases under the influence of the amplification factor V, the loop amplification drops under 1, thus violating the amplitude condition.

In an embodiment of the oscillator circuit the resistance R is set at such a level when the seat belt buckle (1) is closed that the oscillator oscillates in a stable manner. If the seat belt buckle (1) is opened, the leaf spring approaches the sensor and the inductance L(x) is thereby reduced. The resonance frequency of the π-network increases. The oscillator oscillates at a higher frequency.

The change in the oscillator frequency can be used to evaluate the locking condition of a seat belt buckle. If, for example, a micro-controller (μC) is connected to the output of the π-network, the frequency of the voltage U₄ can be measured. Therefore, a thresh-hold value is determined which lies between the “closed” and the “open” condition of the seat belt buckle. If the frequency varies over this thresh-hold, this is signaled by the micro-controller via a data bus or by another suitable analogue signal.

In a further, particularly preferred embodiment of the oscillator circuit, the condition of the seat belt buckle is evaluated by the condition of the oscillation.

The phase displacement of the RC-network is increased by an increase in the frequency also. Through this, at a suitable magnitude, the phase-condition of the oscillator circuit is no longer met and the oscillation ceases.

In addition, the cease of the oscillation due to the non-compliance of the amplitude-conditions can also be caused by suitable dimensioning of the components.

If invertors with frequency-dependant amplification are used, such as, for example, invertors of type 74HCU04, the amplification reduces significantly at frequencies greater than 12 MHz.

If the leaf spring (8) approaches the sensor (9), the frequency increases significantly, for example. As the frequency increases significantly, the amplification reduces significantly. At a suitable dimensioned resistance R, the loop amplification becomes less than 1 and the oscillation ceases.

A simple downstream differentiating circuit can be used to recognize if the oscillator is still oscillating. The oscillation condition, and therefore the condition of the seat belt buckle (1) can be indicated, for example, by an LED or an audible warning, or be transmitted to a control facility by a digital signal.

The above circuits represent a one-port-network with regard to the inductance changes.

In a further, alternative embodiment of the sensor (9), the change in the magnetic coupling factor can be also achieved as represented schematically in FIG. (6) and as described in German Patent Application DE 101 25 278 filed by the applicant, by the change in the magnetic coupling factor of two coupled coils applied in a planar manner instead of by the change in the inductance, caused by the approach of the leaf spring (8). This circuit represents a two-port-network with regard to the inductance changes.

A corresponding sensor circuit comprises the following components which are depicted in FIG. (6): a high frequency current generator Q˜, a feed coil E, a sensor coil S, an amplifier V, an amplitude detector D and a controller A.

The current generator Q˜ generates a high-frequency alternating current which is passed through the feed coil E. This alternating current generates a magnetic field H1, which induces an inductance voltage in the sensor coil. The amplitude of the voltage is dependent on the coupling factor, amongst other things. This inductance voltage is amplified by an amplifier V and passed to the amplitude detector D. The amplitude detector D generates a DC voltage signal, which corresponds with the amplitude of the inductance voltage except for an off-set. This DC voltage signal is further evaluated by the controller A. If the DC voltage signal drops below a certain value, the seat belt buckle is open.

The high frequency current generator Q˜ may, for example, supply a current of approximately 2 mA at a frequency of 12 MHz. For example 100 mVₚₚ are then induced in the sensor coil S. The controller A may, for example, be realized by a switching controller which indicates the decrease in the DC voltage signal below a specific threshold via a bus or by an analogue signal. The sensor may be arranged by two multi-turn conductor loops E and S whereby the conductor loops are concentric, bifilar and planar, and are applied on a printed circuit.

If the seat belt buckle (1) is opened, the leaf spring (8) is close to the circuit board with the sensor (9) and attenuates the inductive coupling of the feed coil and the sensor coil. This causes the inductance voltage to drop, which in turn leads to a reduced DC voltage at the output of the amplitude detector D and to a change over of the controller A.

The embodiments of the sensor and suitable plotting circuits described above serve as an illustration. Further embodiments to use the principle of inductance, variations in the materials and suitable evaluation circuits will immediately be apparent to a person skilled in the art.

### LIST OF REFERENCE SYMBOLS

1 Seat belt buckle

2 Seat belt buckle tongue

3 Ejector

4 Compression spring

5 Moveable magnet

6 Hall sensor

7 Locking component

8 Leaf spring

9 Sensor

V Amplifier

R Resistance

C Capacitor (C₁, C₂)

L(x) Inductance

Q˜ High frequency current generator

E Feed coil

S Sensor coil

D Amplitude detector

A Controller

Although the preferred embodiment has been described, it should be understood that various changes, substitutions, and alterations can be made herein without departing from the scope of the present invention, even if all, one, or some of the advantages identified above are not present. These are only a few of the examples of arrangements and configurations that are contemplated and covered by the present invention.

The various components, configurations, and materials described and illustrated in the preferred embodiment as discrete or separate parts may be combined or integrated with other components and configurations without departing from the scope of the present invention. Other examples of changes, substitutions, and alterations are readily ascertainable by one skilled in the art and could be made without departing from the spirit and scope of the present invention.

What is claimed is:

1. A device for recognizing the locked condition of a seat belt buckle, the device comprising:
a sensor that directly interrogates the condition of the seat belt buckle by a change in inductance.

2. The device of claim 1, wherein the sensor is arranged by a multi-turn conductor loop.

3. The device of claim 2, wherein the conductor loop is applied on a printed circuit.

4. The device of claim 2, wherein the conductor loop is planar.

5. The device of claim 1, further comprising:
an evaluation circuit which continues an oscillator circuit.

6. The device of claim 5, wherein the oscillator circuit further comprises:
a differentiating circuit for the recognition of oscillation.

7. The device of claim 5, wherein the oscillator circuit is evaluated by a micro-controller.

8. The device of claim 1, further comprising
a leaf spring manufactured from a material selected from the group consisting of diamagnetic, paramagnetic and ferromagnetic.

9. The device of claim 1, wherein the sensor is part of a voltage transmission circuit.

10. The device of claim 1, further comprising:
a switching controller for the recognition of a voltage.

11. A seat belt buckle comprising:
a seat belt buckle carrier;
a seat belt buckle tongue;
an ejector;
a locking component; and
a device for recognizing the locked condition of a seat belt buckle according to claim 1.

12. The seat belt buckle of claim 11 wherein the seat belt buckle tongue is manufactured from a material selected from the group consisting of diamagnetic, paramagnetic and ferromagnetic.

13. A device for recognizing a condition of a safety belt buckle, the device comprising:
a sensor that directly interrogates a locked condition by a change in a coupling factor.

14. A device according to claim 13, wherein the sensor is arranged by two multi-turn conductor loops.

15. A device according to claim 14, wherein the multiturn conductor loops are arranged in a concentric and bifilar manner.

16. A device according to claim 14, wherein the conductor loops are applied on a printed circuit.

17. A device according to claim 16, wherein the conductor loops are planar.

18. A device according to claim 13, wherein the device comprises a leaf spring manufactured from a material selected from the group diamagnetic, paramagnetic and ferromagnetic.

19. A device according to claim 13, wherein the sensor is part of a voltage transmission circuit.

20. A device according to claim 13, further comprising:
a switching controller for the recognition of a voltage.

21. A seat belt buckle comprising:
a seat belt buckle carrier;
a seat belt buckle tongue;
an ejector;
a locking component; and
a device for recognizing the locked condition of a seat belt buckle according to claim 13.

22. The seat belt buckle of claim 21, wherein the seat belt buckle tongue is manufactured from a material selected from the group consisting of diamagnetic, paramagnetic and ferromagnetic.
